(19) United States
(12) Patent Application Publication
(10) Pub. No.: US 2026/0172466 A1
(43) Pub. Date: Jun. 18, 2026

(54) SIGNAL-PACKET PROCESSING APPARATUS FOR A VEHICLE TRAIN AND METHODS THEREFOR

(71) Applicant: Bendix Commercial Vehicle Systems LLC, Avon, OH (US)

(72) Inventors: William R. Plow, Avon, OH (US); Alexander J. Augoustidis, Avon Lake, OH (US); Richard A. Romer, Grosse Pointe Park, MI (US)

(73) Assignee: Bendix Commercial Vehicle Systems LLC, Avon, OH (US)

(21) Appl. No.: 18/981,945

(22) Filed: Dec. 16, 2024

(51) Int. Cl. H04L 65/80; H04B 17/318

(52) U.S. Cl. CPC H04L 65/80; H04B 17/318

(57) ABSTRACT

A signal-packet processing apparatus is provided for a vehicle train having a tractor and a number of towed vehicles coupled to the tractor. The signal-packet processing apparatus comprises a towed controller associated with each towed vehicle and arranged to broadcast a corresponding signal packet having a characteristic. The signal-packet processing apparatus also comprises a tractor controller arranged to process the broadcasted signal packet from each towed controller to determine if the characteristic of the corresponding broadcasted signal packet meets predetermined criteria. The tractor controller is arranged to then request the corresponding towed controller to adjust and re-broadcast the broadcasted signal packet when the characteristic of the broadcasted signal packet is determined to meet the predetermined criteria.

### BACKGROUND

The present application relates to vehicle trains, and is particularly directed to a signal-packet processing apparatus for a vehicle train and methods therefor, such as for a vehicle train having a tractor and a number of towed vehicles coupled to the tractor.

In a typical vehicle train having a tractor and a number of towed vehicles coupled to the tractor, each towed vehicle has an associated controller that communicates with a controller of the tractor. Each towed vehicle controller provides towed vehicle information related to its respective towed vehicle. The tractor controller processes the towed vehicle information from the towed vehicles, and provides vehicle control functions based upon the processed information.

Despite advances already made, those skilled in the art continue with research and development efforts in the field of communications between members of a vehicle train, such as a vehicle train having a tractor and a number of towed vehicles coupled to the tractor.

### SUMMARY

In accordance with one embodiment, a signal-packet processing apparatus is provided for a vehicle train having a tractor and a number of towed vehicles coupled to the tractor. The signal-packet processing apparatus comprises a towed controller associated with each towed vehicle and arranged to broadcast a corresponding signal packet having a characteristic. The signal-packet processing apparatus also comprises a tractor controller arranged to process the broadcasted signal packet from each towed controller to determine if the characteristic of the corresponding broadcasted signal packet meets predetermined criteria. The tractor controller is arranged to then request the corresponding towed controller to adjust and re-broadcast the broadcasted signal packet when the characteristic of the broadcasted signal packet is determined to meet the predetermined criteria.

In accordance with another embodiment, a signal-packet processing apparatus is provided for a vehicle train having a tractor and a plurality of towed vehicles coupled to the tractor. The signal-packet processing apparatus comprises a first controller associated with a first towed vehicle of the plurality of towed vehicles and arranged to broadcast a first signal packet having a first characteristic from the first towed vehicle. The signal-packet processing apparatus also comprises a tractor controller associated with the tractor and arranged to (i) receive the first signal packet broadcasted from the first controller, (ii) determine if the first characteristic of the first signal packet meets first predetermined criteria, and (iii) when the first characteristic of the first signal packet meets the first predetermined criteria, send a message to the first controller to request that the first characteristic of the first signal packet be adjusted and then re-broadcasted from the first controller.

In accordance with yet another embodiment, a method is provided of operating a signal-packet processing apparatus to process signal packets between a tractor and each towed vehicle of a number of towed vehicles coupled to the tractor. The method comprises broadcasting from each towed vehicle a signal packet, and receiving at the tractor the signal packet from each towed vehicle. The method also comprises determining at the tractor if the signal packet from each towed vehicle has a receive power that meets predetermined criteria. The method further comprises sending from the tractor a signal packet to a towed vehicle to notify that towed vehicle that the receive power of the signal packet broadcasted from that towed vehicle as determined by the tractor meets the predetermined criteria.

### BRIEF DESCRIPTION OF THE DRAWINGS

FIG. 1 is a pictorial diagram of a vehicle train embodying an example signal-packet processing apparatus constructed in accordance with the present disclosure.

FIG. 2 is a schematic block diagram of a tractor controller of the signal-packet processing apparatus shown in FIG. 1.

FIG. 3 is a schematic block diagram of a towed controller of the signal-packet processing apparatus shown in FIG. 1.

FIG. 4 is a flow diagram depicting a method of operating the towed controller of FIG. 3 in accordance with an embodiment.

FIG. 5 is a flow diagram depicting a method of operating the tractor controller of FIG. 2 in accordance with an embodiment.

FIG. 5A is a flow diagram similar to the flow diagram of FIG. 5 and depicting a method of operating the tractor controller of FIG. 2 in accordance with another embodiment.

FIG. 6 is a flow diagram depicting a method of operating the signal-packet processing apparatus of FIG. 1 in accordance with an embodiment.

### DETAILED DESCRIPTION

The present application is directed to a signal-packet processing apparatus for a vehicle train and methods therefor, such as for a vehicle train having a tractor and a number of towed vehicles coupled to the tractor. The specific construction of the signal-packet processing apparatus may vary. It is to be understood that the disclosure below provides a number of embodiments or examples for implementing different features of various embodiments. Specific examples of components and arrangements are described to simplify the present disclosure. These are merely examples and are not intended to be limiting.

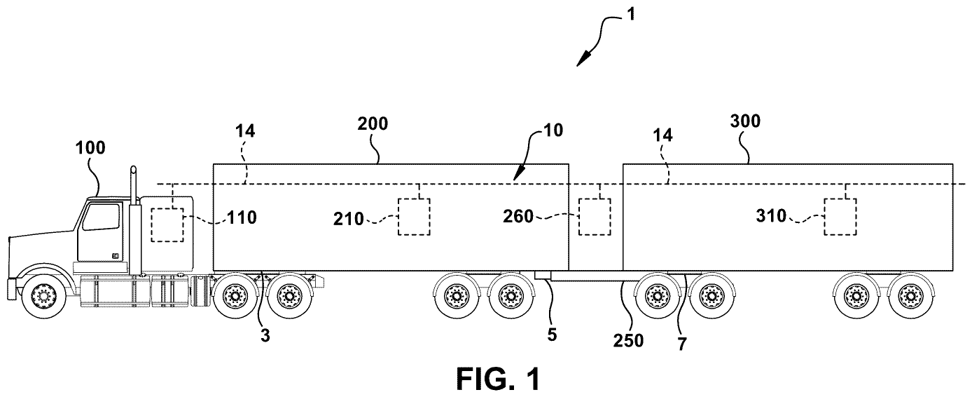

Referring to FIG. 1, a pictorial diagram is illustrated of a vehicle train 1 embodying an example signal-packet processing apparatus 10 constructed in accordance with the present disclosure. The vehicle train 1 has a tractor 100 and a plurality of towed vehicles including first trailer 200, dolly 250, and second trailer 300 coupled to the tractor 100. A mechanical coupling 3 mechanically interconnects the tractor 100 and the first trailer 200 in known and conventional manner. The dolly 250 includes a hook portion 5 that connects to rear end of the first trailer 200, and a plate portion 7 that connects to front end of the second trailer 300. The dolly 250 mechanically interconnects the first trailer 200 and the second trailer 300 in known and conventional manner.

Although the above description describes three towed vehicles (i.e., the first trailer 200, the dolly 250, and the second trailer 300) coupled to the tractor 100, it is conceivable that any number of towed vehicles can be coupled to the tractor 100. As an example, five towed vehicles (i.e., three trailers and two dollies) may be coupled to the tractor 100.

The signal-packet processing apparatus 10 includes an electronic controller unit (ECU) 110 of the tractor 100, an ECU 210 of the first trailer 200, an ECU 260 of the dolly 250, and an ECU 310 of the second trailer 300. The ECU 110 is referred to herein as “the tractor controller 110”, the ECU 210 is referred to herein as “the first controller 210” or “the towed controller 210”, the ECU 260 is referred to herein as “the dolly controller 260” or “the towed controller 260”, and the ECU 310 is referred to herein as “the second controller 310” or “the towed controller 310”. Each of the controllers 110, 210, 260, 310 is connected to a communication line 14.

The communication line 14 may comprise a controller area network (CAN) bus to which a number of vehicle devices are connected to communicate with each other. As an example, the communication line 14 may be a 12 VDC power line with PLC signal SAE J2497. As another example, the CAN bus may be in a standardized serial communication format, such as SAE J1939, or in a proprietary format. The communication line 14 creates a communication path through tractor and trailers that may or may not be shown or described herein via wired (e.g., controller area network (CAN), ethernet, automotive ethernet, power line carrier, etc.) or wireless (e.g., WiFi, Bluetooth, cellular, etc.) connections. In the example in FIG. 1, the components are directly or indirectly connected via the communication line 14, which can take the form of a controller area network (e.g., J1939, ISO 11992, J2497, or proprietary format). Other types of network communication are possible.

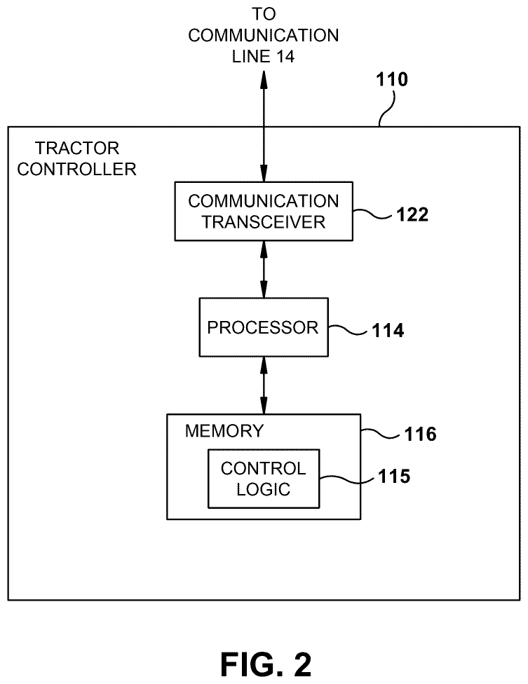

Referring to FIG. 2, a schematic block diagram of the tractor controller 110 is illustrated. The tractor controller 110 includes a processor 114 that executes instructions of control logic 115 stored in an internal memory 116, external memory (not shown), or a combination thereof. The processor 114 may comprise any type of technology. For example, the processor 114 may comprise a general-purpose electronic processor. Other types of processors and technologies are possible. The internal memory 116 may comprise any type of technology. For example, the internal memory 116 may comprise random access memory (RAM), read only memory (ROM), solid state memory, or any combination thereof. Other types of memories and data storage technologies are possible.

A communication transceiver 122 enables the tractor controller 110 to send/receive signals to/from the communication line 14. Structure and operation of transceiver circuits are known and, therefore, will not be described. The transceiver circuits may send/receive signals based upon any type of network communication of the communication line 14.

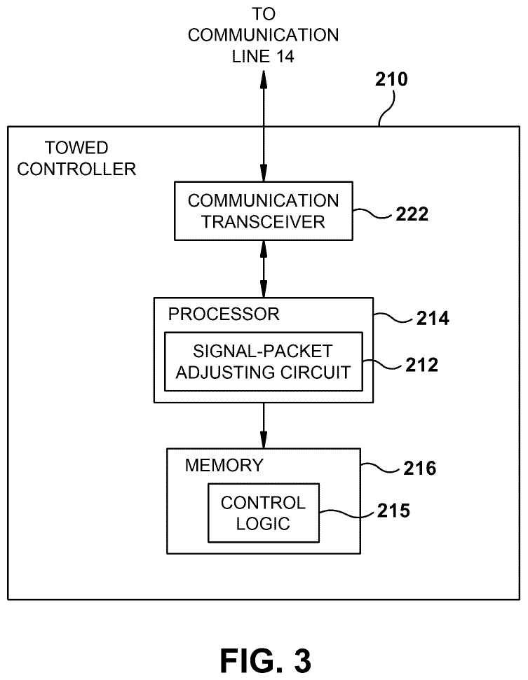

Referring to FIG. 3, a schematic block diagram of each of the towed controllers 210, 260, 310 is illustrated. Each of the first, second, and third towed controllers 210, 260, 310 may comprise components similar to components of the tractor controller 110 described hereinabove. Each of the towed controllers 210, 260, 310 is constructed and operates in similar manner. For simplicity and purpose of explanation, components and operation of only the first towed controller 210 are described with reference to FIG. 3.

As shown in FIG. 3, the first controller 210 includes a processor 214 that executes instructions of control logic 215 stored in an internal memory 216, external memory (not shown), or a combination thereof. The processor 214 includes a signal-packet adjusting circuit 212, such as a circuit that adjusts transmit power of a signal packet. As an example, the signal-packet adjusting circuit 212 may be arranged to increase transmit power of a signal packet broadcasted from the first controller 210. Other types of signal-packet adjusting circuits are possible.

Although the signal-packet adjusting circuit 212 in FIG. 3 as being located within the processor 214, it is conceivable that the signal-packet adjusting circuit 212 be located outside of the processor 214 and within the first controller 210. It is also conceivable that the signal-packet adjusting circuit 212 be located outside of the first controller 210. The signal-packet adjusting circuit 212 may comprise any combination of hardware components, software components, and firmware components.

The processor 214 may comprise any type of technology. For example, the processor 214 may comprise a general-purpose electronic processor. Other types of processors and technologies are possible. The internal memory 216 may comprise any type of technology. For example, the internal memory 216 may comprise random access memory (RAM), read only memory (ROM), solid state memory, or any combination thereof. Other types of memories and data storage technologies are possible.

A communication transceiver 222 enables the processor 214 to send/receive signals to/from the communication line 14. Structure and operation of transceiver circuits are known and, therefore, will not be described. The transceiver circuits may send/receive signals based upon any type of network communication of the communication line 14.

The first controller 210 is arranged to broadcast a signal packet along the communication line 14 for other controllers of the vehicle train 1 (shown in FIG. 1) to receive. The other controllers to which the signal packet is broadcasted in vicinity of the first controller 210 include, but are not limited to, the tractor controller 110, the dolly controller 260, and the second controller 310 (all shown in FIG. 1). Identification information such as an identification number associated with the first towed vehicle 200, and thus also associated with the first controller 210, is also broadcasted.

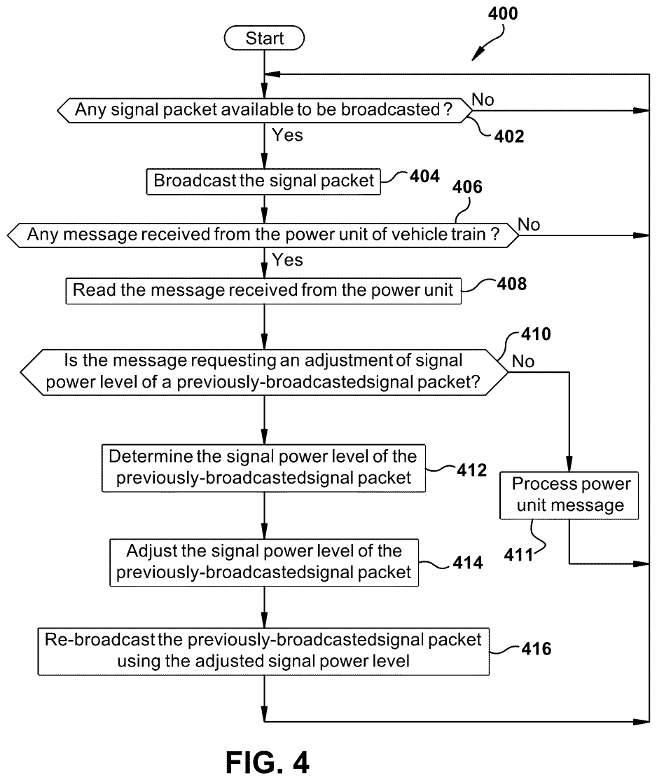

Referring to FIG. 4, a flow diagram 400 depicts a method of operating the first controller 210 of FIG. 3 in accordance with an embodiment. The flow diagram 400 is an embodiment of the control logic 215 shown in FIG. 3.

In block 402, a determination is made as to whether a signal packet is available to be broadcasted from the first controller 210. If the determination in block 402 is negative (i.e., there is no signal packet available to be broadcasted), the process loops back on itself to continue monitoring for a signal packet to be broadcasted. However, if the determination in block 402 is affirmative (i.e., a signal packet is available to be broadcasted), the process proceeds to block 404 to broadcast the signal packet. The signal packet includes the identification number associated with the particular towed controller, which in this example is the first controller 210. The signal packet may or may not include an indicator of the transmit power of the signal packet broadcasted. The process then proceeds to block 406.

In block 406, a determination is made as to whether a message (e.g., a signal packet) is received from the tractor controller 110, which is the power unit of the vehicle train 1. If the determination in block 406 is negative (i.e., no message received from the tractor controller 110), the process returns back to block 402. However, if the determination in block 406 is affirmative (i.e., a message is received from the tractor controller 110), the process proceed to block 408 in which the received message is read.

Then in block 410, a determination is made as to whether the message is requesting an adjustment of the signal power level (i.e., signal strength) of a previously-broadcasted signal packet. If the determination in block 410 is negative (i.e., there is no request from the tractor controller 110), the process proceeds to block 411 in which the power unit message (i.e., the message received from the tractor controller 110) is processed. However, if the determination in block 410 is affirmative (i.e., there is a request from the tractor controller 110), the process proceeds to block 412 in which the signal power level of the previously-broadcasted signal packet is determined before proceeding to block 414.

In block 414, the signal power level of the previously-broadcasted signal packet is adjusted. As an example, the transmit power level of the previously-broadcasted signal packet is increased by a gain factor. The gain factor may comprise a positive value or a negative value to provide gain control. For example, the gain factor may comprise a positive value that is equal to “1” in which there is no gain, a positive value that is greater than “1” in which there is a positive gain (i.e., an amplification), or a positive value that between zero and “1” in which there is a negative gain (i.e., an attenuation). Alternatively, the transmit power level of the previously-broadcasted signal packet may be increased by a percentage.

The process proceeds to block 416 in which the previously-broadcasted signal packet using the adjusted signal power level (i.e., the transmit power level) is re-broadcasted along the communication line 14 (FIG. 1). The process then returns back to the “Start” block.

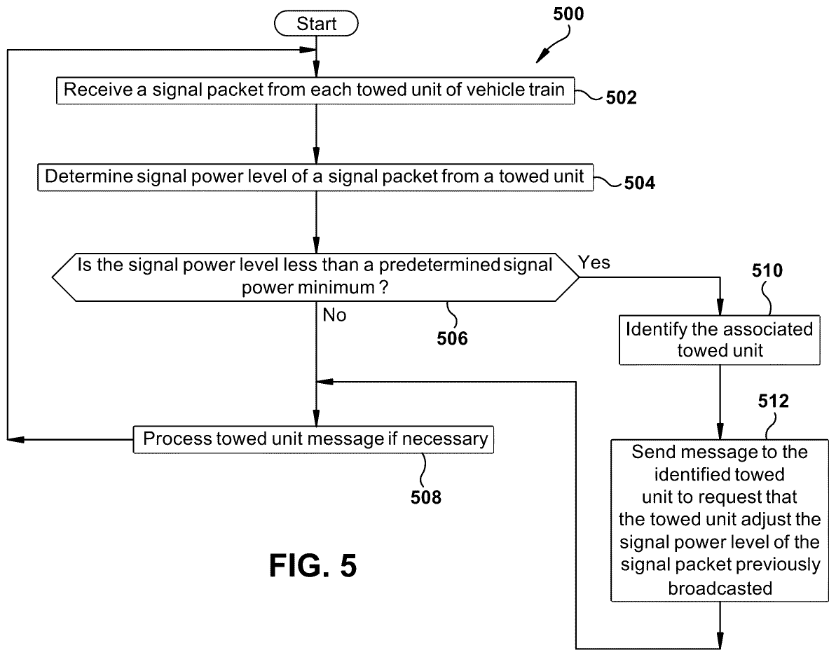

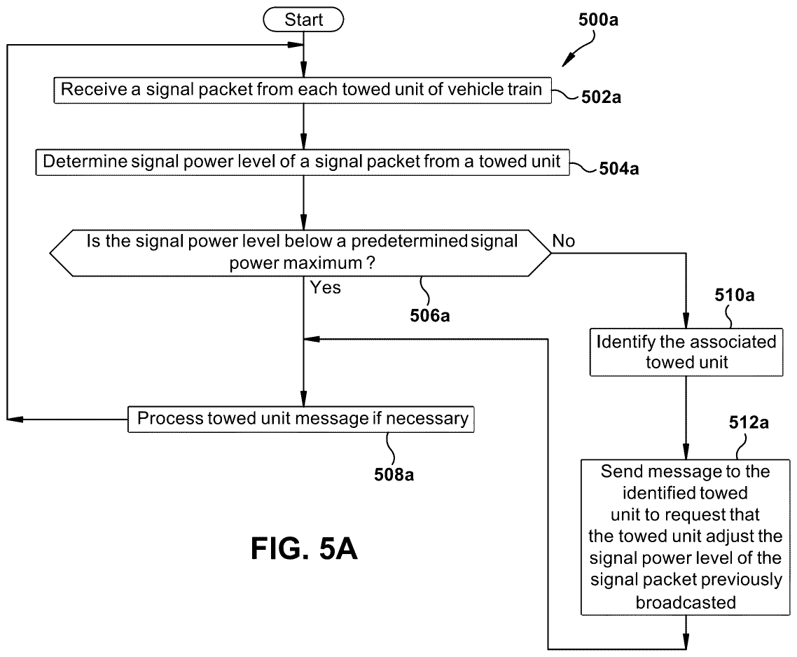

Referring to FIG. 5, a flow diagram 500 depicts a method of operating the tractor controller 110 of FIG. 2 in accordance with an embodiment. The flow diagram 500 is an embodiment of the control logic 115 shown in FIG. 2.

In block 502, a signal packet is received from each towed unit (i.e., from each of the towed controllers 210, 260, 310 as shown in FIG. 1) of the vehicle train 1. Then in block 504, the signal power level of a signal packet from a towed unit (i.e., from its corresponding towed controller) is determined before proceeding to block 506.

In block 506, a determination is made as to whether the signal power level of the signal packet from block 504 is less than a predetermined signal power minimum. As an example, J2497 (i.e., J2497_202311: Power Line Carrier Communications for Commercial Vehicles—SAE International) requires a peak-to-peak voltage (pseudo-signal power) minimum of 2.5 Volts. If the determination in block 506 is negative, the process proceeds to block 508. However, if the determination in block 506 is affirmative, the process proceeds to block 510 in which the towed unit associated with the signal packet from block 504 is identified.

The process then proceeds to block 512 in which a message (e.g., a signal packet) is sent to the towed unit identified in block 510 to request that the towed unit adjust the signal power level of the signal packet previously broadcasted (i.e., the signal packet from block 504). The process proceeds to block 508.

In block 508, the packet content received from the towed unit is then processed if necessary. Then, the process returns back to the “Start” to process the next-available signal packet in the same manner as described hereinabove.

Referring to FIG. 5A, a flow diagram 500a is similar to the flow diagram 500 of FIG. 5, and depicts a method of operating the tractor controller 110 of FIG. 2 in accordance with another embodiment. The blocks of the flow diagram 500a of FIG. 5A are the same as the blocks of the flow diagram 500 of FIG. 5, except that block 506a shown in FIG. 5A replaces block 506 shown in FIG. 5.

In block 506a of FIG. 5A, a determination is made as to whether the signal power level of a signal packet is below a predetermined signal power maximum. As an example, J2497 requires a peak-to-peak voltage (pseudo-signal power) maximum of 7.0 Volts. If the determination in block 506a is affirmative, the process proceeds to block 508a which is functionally the same as block 508 in FIG. 5. However, if the determination in block 506a is negative, the process proceeds to block 510a which is functionally the same as block 510 in FIG. 5.

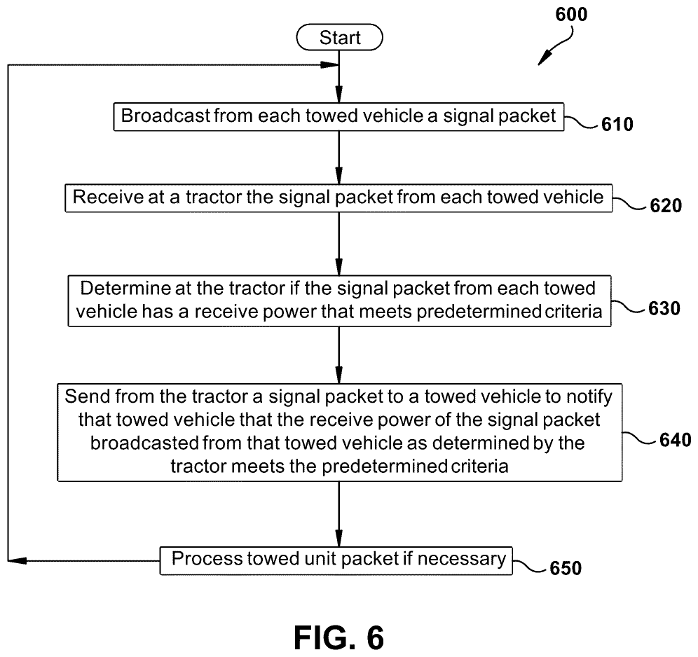

Referring to FIG. 6, a flow diagram 600 depicts a method of operating the signal-packet processing apparatus 10 of FIG. 1 in accordance with an embodiment. The signal-packet processing apparatus 10 processes signal packets between a tractor and each towed vehicle of a number of towed vehicles coupled to the tractor.

In block 610, a signal packet is broadcasted from each towed vehicle. The process proceeds to block 620 in which the signal packet from each towed vehicle is received at the tractor. Then in block 630, a determination is made at the tractor if the signal packet from each towed vehicle has a receive power that meets predetermined criteria. The process proceeds to block 640.

In block 640, a signal packet is sent from the tractor to a towed vehicle to notify that towed vehicle that the receive power of the signal packet broadcasted from that towed vehicle as determined by the tractor meets the predetermined criteria. In block 650, the packet content received from the towed unit is then processed if necessary. The process then returns to the “Start”.

In some embodiments, the signal packet broadcasted from each towed vehicle has an indication of transmit power of the signal packet being broadcasted.

In some embodiments, the signal packet broadcasted from each towed vehicle has no indication of transmit power of the signal packet being broadcasted.

In some embodiments, the signal packet sent from the tractor to the corresponding towed vehicle has an indication of receive power of the signal packet received from the towed vehicle to notify the towed vehicle that the receive power of the signal packet broadcasted from the towed vehicle as determined by the tractor meets the predetermined criteria.

In some embodiments, the signal packet sent from the tractor to the corresponding towed vehicle has no indication of receive power of the signal packet received from the towed vehicle to notify the towed vehicle that the receive power of the signal packet broadcasted from the towed vehicle as determined by the tractor meets the predetermined criteria.

In some embodiments, a determination is made at the tractor if the signal packet from each towed vehicle has a receive power that is less than a predetermined signal strength minimum.

In some embodiments, a determination is made at the tractor if the signal packet from each towed vehicle has a receive power that is below a predetermined signal strength maximum.

It should be apparent that a determination (i.e., a first determination) is made as to whether a first characteristic (e.g., the transmit strength) of a first signal packet meets first predetermined criteria. Then, another determination (i.e., a second determination) is made as to whether a second characteristic of a second signal packet meets second predetermined criteria which may be the same as the first predetermined criteria. Although each of the first and second characteristics described herein is transmit strength, other characteristics are possible.

In some embodiments, the method is performed by a controller having a memory executing one or more programs of instructions which are tangibly embodied in a program storage medium readable by the controller.

A number of advantages result by providing the vehicle train 1 with the above-described signal-packet processing apparatus 10. One advantage is that reliability of signal-packet information received by the tractor controller 110 from the towed controllers 210, 260, 310 is improved. If the received power of any signal packet is too weak (i.e., does not meet predetermined criteria), the tractor controller 110 can send a message to the corresponding towed controller to request an adjustment of the transmit power of the previously-broadcasted signal packet and a re-broadcast the signal packet with the adjusted transmit power.

Another advantage is that each towed controller need only include its unique identification information in a broadcasted signal packet. The tractor controller 110 needs only the unique identification information of a towed controller to communicate with that towed controller and request the towed controller to adjust the transmit power of the previously-broadcasted signal packet. The towed controller need not include the transmit power in any signal packet that is broadcasted.

Program instructions for enabling each of the controllers 110, 210, 260, 310 (FIG. 1) to perform operation steps in accordance with corresponding flow diagrams may be embedded in memory internal to each respective controller. Alternatively, or in addition to, program instructions may be stored in memory external to each respective controller. As an example, program instructions may be stored in memory internal to a different controller of the vehicle. Program instructions may be stored on any type of program storage media including, but not limited to, external hard drives, flash drives, and compact discs. Program instructions may be reprogrammed depending upon features of the particular controller.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above description describes use of only one controller in the tractor 100 and only one controller in each of the dolly 250 and the first and second trailers 200, 300, it is conceivable that any number of controllers may be used. Moreover, it is conceivable that any type of controller may be used. Suitable controllers for use in vehicles are known and, therefore, have not been described. Accordingly, the program instructions of the present disclosure can be stored on program storage media associated with one or more vehicle controllers.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A signal-packet processing apparatus for a vehicle train having a tractor and a number of towed vehicles coupled to the tractor, the signal-packet processing apparatus comprising:
a towed controller associated with each towed vehicle and arranged to broadcast a corresponding signal packet having a characteristic; and
a tractor controller arranged to process the broadcasted signal packet from each towed controller to determine if the characteristic of the corresponding broadcasted signal packet meets predetermined criteria, and then to request the corresponding towed controller to adjust and re-broadcast the broadcasted signal packet when the characteristic of the broadcasted signal packet is determined to meet the predetermined criteria.

2. The signal-packet processing apparatus according to claim 1, wherein the corresponding towed controller is arranged to (i) adjust its previously-broadcasted signal packet to provide an adjusted signal packet by increasing transmit power of the previously-broadcasted signal packet by a gain factor, and (ii) re-broadcast the adjusted signal packet.

3. The signal-packet processing apparatus according to claim 1, wherein (i) the predetermined criteria comprises a predetermined signal strength minimum, and (ii) the tractor controller is arranged to determine if the corresponding signal packet from each towed vehicle has a receive power that is less than the predetermined signal strength minimum.

4. The signal-packet processing apparatus according to claim 1, wherein (i) the predetermined criteria comprises a predetermined signal strength maximum, and (ii) the tractor controller is arranged to determine if the corresponding signal packet from each towed vehicle has a receive power that is below the predetermined signal strength maximum.

5. A signal-packet processing apparatus for a vehicle train having a tractor and a plurality of towed vehicles coupled to the tractor, the signal-packet processing apparatus comprising:
a first controller associated with a first towed vehicle of the plurality of towed vehicles and arranged to broadcast a first signal packet having a first characteristic from the first towed vehicle; and
a tractor controller associated with the tractor and arranged to (i) receive the first signal packet broadcasted from the first controller, (ii) determine if the first characteristic of the first signal packet meets first predetermined criteria, and (iii) when the first characteristic of the first signal packet meets the first predetermined criteria, send a message to the first controller to request that the first characteristic of the first signal packet be adjusted and then re-broadcasted from the first controller.

6. The signal-packet processing apparatus according to claim 5, wherein the first controller is further arranged to increase the first characteristic of the first signal packet broadcasted from the first controller.

7. The signal-packet processing apparatus according to claim 6, wherein the message sent from the tractor controller to the first controller includes a request that the first characteristic of the first signal packet that has been broadcasted from the first controller be increased by a gain factor and then be re-broadcasted from the first controller.

8. The signal-packet processing apparatus according to claim 6, wherein the first characteristic of the first signal packet comprises transmit power of the first signal packet that has been broadcasted from the first controller.

9. The signal-packet processing apparatus according to claim 5 further comprising:
a second controller associated with a second towed vehicle of the plurality of towed vehicles and arranged to increase a second characteristic of a second signal packet broadcasted from the second controller;
wherein the tractor controller is further arranged to (i) receive the second signal packet broadcasted from the second controller, (ii) determine if the second characteristic of the second signal packet meets second predetermined criteria, and (iii) when the second characteristic of the second signal packet meets the second predetermined criteria, send a message to the second controller to request that the second characteristic of the second signal packet be adjusted and then re-broadcasted from the second controller.

10. The signal-packet processing apparatus according to claim 9, wherein each of the first and second characteristics comprises transmit power of the corresponding signal.

11. The signal-packet processing apparatus according to claim 9, wherein each of the first and second characteristics comprises a characteristic that is other than transmit power of the corresponding signal.

12. The signal-packet processing apparatus according to claim 5, wherein (i) the first predetermined criteria comprises a predetermined signal strength minimum, and (ii) the tractor controller is arranged to determine if the first characteristic of the first signal packet is less than the predetermined signal strength minimum and then to send the message to the first controller to request that the first characteristic of the first signal packet be increased and re-broadcasted from the first controller when the first characteristic of the first signal packet is less than the predetermined signal strength minimum.

13. The signal-packet processing apparatus according to claim 5, wherein (i) the first predetermined criteria comprises a predetermined signal strength maximum, and (ii) the tractor controller is arranged to determine if the first characteristic of the first signal packet is below the predetermined signal strength maximum and then to send the message to the first controller to request that the first characteristic of the first signal packet be increased and re-broadcasted from the first controller when the first characteristic of the first signal packet is not below the predetermined signal strength maximum.

14. A method of operating a signal-packet processing apparatus to process signal packets between a tractor and each towed vehicle of a number of towed vehicles coupled to the tractor, the method comprising:
broadcasting from each towed vehicle a signal packet;
receiving at the tractor the signal packet from each towed vehicle;
determining at the tractor if the signal packet from each towed vehicle has a receive power that meets predetermined criteria; and
sending from the tractor a signal packet to a towed vehicle to notify that towed vehicle that the receive power of the signal packet broadcasted from that towed vehicle as determined by the tractor meets the predetermined criteria.

15. The method according to claim 14, wherein broadcasting from each towed vehicle a signal packet includes:
broadcasting from each towed vehicle a signal packet having an indication of transmit power of the signal packet being broadcasted.

16. The method according to claim 14, wherein broadcasting from each towed vehicle a signal packet includes:
broadcasting from each towed vehicle a signal packet having no indication of transmit power of the signal packet being broadcasted.

17. The method according to claim 14, wherein sending from the tractor a signal packet to a towed vehicle to notify that towed vehicle that the receive power of the signal packet broadcasted from that towed vehicle as determined by the tractor meets the predetermined criteria includes:
sending from the tractor to the corresponding towed vehicle a signal packet having an indication of receive power of the signal packet received from the towed vehicle to notify the towed vehicle that the receive power of the signal packet broadcasted from the towed vehicle as determined by the tractor meets the predetermined criteria.

18. The method according to claim 14, wherein sending from the tractor a signal packet to a towed vehicle to notify that towed vehicle that the receive power of the signal packet broadcasted from that towed vehicle as determined by the tractor meets the predetermined criteria includes:
sending from the tractor to the corresponding towed vehicle a signal packet having no indication of receive power of the signal packet received from the towed vehicle to notify the towed vehicle that the receive power of the signal packet broadcasted from the towed vehicle as determined by the tractor meets the predetermined criteria.

19. The method according to claim 14, wherein determining at the tractor if the signal packet from each towed vehicle has a receive power that meets predetermined criteria includes:
determining at the tractor if the signal packet from each towed vehicle has a receive power that is less than a predetermined signal strength minimum.

20. The method according to claim 14, wherein determining at the tractor if the signal packet from each towed vehicle has a receive power that meets predetermined criteria includes:
determining at the tractor if the signal packet from each towed vehicle has a receive power that is below a predetermined signal strength maximum.

21. The method according to claim 14, wherein the method is performed by a controller having a memory executing one or more programs of instructions which are tangibly embodied in a program storage medium readable by the controller.
